(19) United States
(12) Patent Application Publication
(10) Pub. No.: US 2008/0057315 A1
(43) Pub. Date: Mar. 6, 2008

(54) METHOD OF APPLICATION OF HEAT-SHRINKABLE ARTICLES

(75) Inventors: Edward Alaerts, Herselt (BE); Sirarpi Bicakci-Jenkins, San Diego, CA (US); Abboud L. Mamish, Marlborough, MA (US)

Correspondence Address: RAYMOND R. MOSER JR., ESQ.;MOSER IP LAW GROUP, 1030 BROAD STREET, 2ND FLOOR, SHREWSBURY, NJ, 07702, US

(73) Assignee: COVALENCE SPECIALTY MATERIALS CORP., Minneapolis, MN (US)

(21) Appl. No.: 11/613,568

(22) Filed: Dec. 20, 2006

Related U.S. Application Data
(63) Continuation-in-part of application No. 11/469,787, filed on Sep. 1, 2006.

(51) Int. Cl. B32B 27/38; B32B 27/32

(52) U.S. Cl. 428/413; 428/523; 428/910

(57) ABSTRACT

A method comprises providing a thermoset cross-linked polymeric heat-shrinkable article having a first end and a second end, wherein the first end has at least one extended portion and one non-extended portion, wherein the second end has a first area and a first edge portion, applying an adhesive compound to the heat-shrinkable article, applying the heat-shrinkable article to an apparatus, positioning the heat-shrinkable article to the apparatus such that the adhesive compound contacts the apparatus, layering the at least one extended portion onto the first area of the second end, abutting the at least one non-extended portion to the first edge portion of the second end, and causing heat-shrinkage of the heat-shrinkable article.

### CROSS-REFERENCE TO RELATED APPLICATIONS

This application is a continuation-in-part of U.S. patent application Ser. No. 11/469,787, filed on Sep. 1, 2006, of which is incorporated herein by reference in its entirety.

### BACKGROUND

1. Field of the Invention

Embodiments of the present invention generally relate to heat-shrinkable articles, and more specifically, to heat-shrinkable articles made of thermoset cross-linked polymeric compositions and methods of application.

2. Description of the Related Art

Heat-shrinkable articles have dimensional configurations that change somewhat uniformly when subjected to an appropriate amount of heat. Typically, heat-shrinkable articles comprise tubing, sheets, sleeves, and other molded shapes made from a polymeric material, such as polyethylene. Alternately, some heat-shrinkable articles comprise woven fabrics in conjunction with a polymeric matrix formed by applying a polymeric material to one or both sides of the woven fabric to render the article impermeable to moisture.

Commonly, heat-shrinkable articles are made predominantly of polyethylene, which imparts preferred characteristics to such articles, including better conformability, over articles made primarily of other polyolefins. For example, heat-shrinkable sleeves used for the corrosion protection of high temperature pipeline joints typically are made with more than 50 percent by weight of polyethylene to impart conformability and integrity at the operating temperature of the pipeline.

Drawbacks associated with polyethylene-predominated heat-shrinkable articles include lack of rigidity and stability at high operating temperatures, such as temperatures greater than 120 degrees Celsius.

Other heat-shrinkable articles are made predominantly of polypropylene, which overcomes the drawbacks associated with using a predominant amount of polyethylene. Polypropylene imparts characteristics including high rigidity and toughness sustained at high operating temperatures. However, heat-shrinkable articles made predominantly of polypropylene lack conformability and property retention, such as, for example, tensile elongation, after exposure for long durations at elevated temperatures, such as, for example, 140 degrees Celsius and above.

Such heat-shrinkable articles may be applied in a variety of operations. For example, heat-shrinkable sleeves often are applied to adjoin two pipes end-to-end. When such a sleeve is applied to the pipe ends, the sleeve may cover a portion of each pipe. This includes a section of exposed pipe metal and a portion of a pipe coating, such as a thermoplastic corrosion protective coating, previously applied to each pipe. Typically, when the sleeve is applied, the ends of the sleeve initially overlap to close where the ends cover the exposed pipe metal and the portion of the pipe coating. Heat then is applied to shrink the sleeve and activate an adhesive compound applied to the bottom surface of the sleeve, adjacent to the pipe. This method is intended to cause the sleeve to conform and bond to the pipe and seal the pipe joint.

When heating the sleeve during this type of application, a bonding temperature is selected to activate the adhesive compound, such that a proper bond adhesion is achieved between the sleeve and the pipes, and the sufficient shrinkage occurs to conform the sleeve to the pipes. If the two sleeve ends overlap when heat is applied, the heat must penetrate through the overlap to activate the adhesive compound for the sleeve to bond to the pipe.

A drawback associated with this method of application is a lack of adhesion of the overlapping portions of the sleeve ends to the protective coating, as shown in FIG. 1. In FIG. 1, a system 100 comprises a pipe 102 and a heat-shrinkable pipe sleeve 104 applied to the pipe 102. The heat-sleeve 104 is applied to cover an area of exposed pipe metal 106 and a coated area 108 of the pipe 102, where the coating 108 may be a protective coating, such as a corrosion protective thermoplastic coating, for example, polypropylene. As shown in FIG. 1, a lack of adhesion 110 occurs where ends of the heat-sleeve 104 overlap and cover the protective coating 108. This is due to the pipe metal 106, such as, for example steel, having a lower bond temperature for proper adhesion of the sleeve than the protective coating 108. Thus, while the heat penetration rate is sufficient to penetrate the overlapped ends of the heat-sleeve 104 covering the exposed pipe metal 106, the heat penetration rate is insufficient to effectively penetrate the overlapped ends of the heat-sleeve 104 covering the protective coating 108 and adhere the heat-sleeve 104 to the protective coating 108. However, increasing the bond temperature to sufficiently penetrate the overlapped ends of the heat-sleeve 104 covering the protective coating 108 overheats the overlapped ends of the heat-sleeve 104 covering the exposed pipe metal 106, thereby degrading the heat-sleeve 104 adhesion to the pipe metal 106.

A solution to this problem comprises applying the heat-shrinkable sleeve to a pipe and abutting the ends of the sleeve prior to the heat application, instead of overlapping the ends. However, due to the amount of shrinkage of the heat-sleeve occurring during the heating application, which typically is about 25% from the pre-application dimensions of the heat-sleeve, the ends may pull away from each other, leaving an area of the pipe uncovered and unprotected by the heat-sleeve.

Thus, it is desired to provide a method of applying a heat-shrinkable article to an apparatus with multiple bonding temperatures, such that both the adhesion of the sleeve to the apparatus and the conformity of the sleeve to the apparatus are optimized. It also desired to provide an article of manufacture capable of adhering to an apparatus having multiple bonding temperature requirements.

### SUMMARY

An embodiment of the present invention includes a method providing a heat-shrinkable article comprising a thermoset cross-linked polymeric composition having at least one polypropylene polymer, and at least one polyethylene polymer, the thermoset cross-linked polymeric composition having a polypropylene content of less than about 50 percent by weight, and having a polyethylene content of less than about 50 percent by weight, based on the total weight of the cross-linked polymeric composition, the heat-shrinkable article having a first end and a second end, wherein the first end has at least one extended portion and one non-extended portion, wherein the second end has a first area and a first edge portion; applying an adhesive compound to the heat-shrinkable article; applying the heat-shrinkable article to an apparatus; positioning the heat-shrinkable article to the apparatus such that the adhesive compound contacts the apparatus; layering the at least one extended portion onto the first area of the second end; abutting the at least one non-extended portion to the first edge portion of the second end; and, causing heat-shrinkage of the heat-shrinkable article.

Another embodiment of the present invention includes a method comprising providing a thermoset cross-linked polymeric heat-shrinkable article having a first end and a second end, wherein the first end has at least one extended portion and one non-extended portion, wherein the second end has a first area and a first edge portion; applying the heat-shrinkable article to an apparatus; layering the at least one extended portion onto the first area of the second end; abutting the at least one non-extended portion to the first edge portion of the second end; and causing heat-shrinkage of the heat-shrinkable article.

Another embodiment of the present invention includes a thermoset cross-linked polymeric heat-shrinkable article, comprising a first end having at least one extended portion and one non-extended portion; a second end having a first area and a first edge portion; and an adhesive compound applied to the heat-shrinkable article.

### BRIEF DESCRIPTION OF THE DRAWINGS

FIG. 1 is a photograph depicting a lack of adhesion by a heat-shrinkable sleeve applied to a pipe;

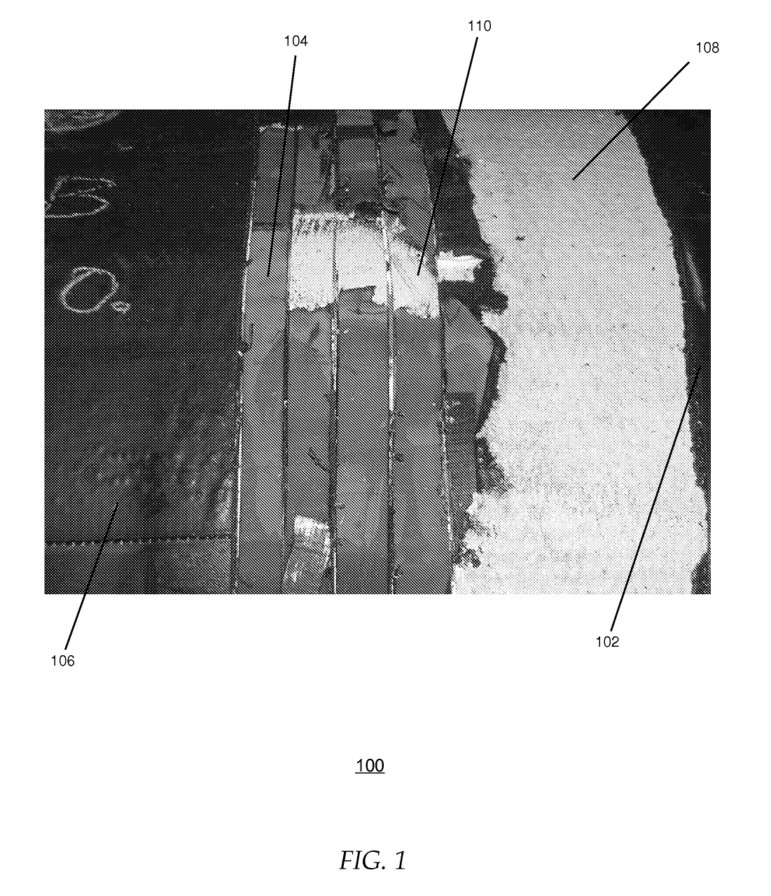

FIG. 2 illustrates a heat-shrinkable article, in accordance with an embodiment of the present invention;

FIGS. 3A and 3B present a heat-shrinkable article in application, in accordance with an embodiment of the present invention; and

FIG. 4 presents a method of applying a heat-shrinkable article, in accordance with an embodiment of the present invention.

### DETAILED DESCRIPTION

Embodiments of the present invention are directed to a method of application of heat-shrinkable articles to an apparatus, such as, for example, a conduit, an air duct, a piping apparatus, and the like. In an embodiment of the present invention, a method of application of a heat-shrinkable article comprising thermoset cross-linked polymeric compositions that comprise less than about 50 percent by weight of a polypropylene polymer is provided.

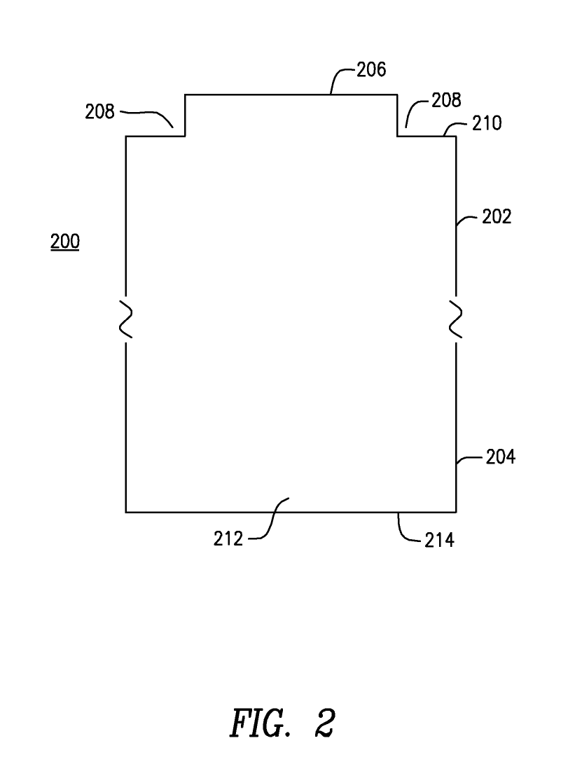

As shown in FIG. 2, a heat-shrinkable article 200, such as a heat-sleeve, is depicted having a first end 202 and a second end 204. The first end 202 has at least one extended portion 206 and at least one non-extended portion 208 having an edge portion 210, and the second end 204 has a first area 212 and a first edge portion 214. In one embodiment of the present invention, the extended portion 206 and the non-extended portion 208 of the article 200 may be preformed during the manufacture of the article 200. In another embodiment of the present invention, the extended portion 206 and the non-extended portion 208 of the article 200 are formed just prior to application of the article 200. The shape and dimensions of the extended portion 206 and the non-extended portion 208 may be customized according to the specific application of the article 200, and are not limited to a specific embodiment. In yet another embodiment of the present invention, a heat-shrinkable article 200 has a first end 202 with two non-extended portions 208 and an extended portion 206 juxtaposed between the non-extended portions 208, as shown in FIG. 2.

Other embodiments of the present invention include a heat-shrinkable article 200 having a first end 202, wherein the first end 202 has multiple extended portions 206 and multiple non-extended portions 208, arranged in a design based upon the specific application. One embodiment of the present invention includes a heat-shrinkable article 200 having a first end 202 and a second end 204, wherein the first end 202 has multiple extended portions 206 and multiple non-extended portions 208 positioned adjacent to each other.

The article 200 may have an adhesive compound applied to a side of the article 200, such that the adhesive compound contacts the apparatus when the article 200 is applied in operation. The adhesive compound may be a heat-sealing adhesive, a pressure sensitive adhesive, a combination of the two, and the like. An example of an adhesive compound is described in U.S. Pat. No. 6,841,212, entitled “Heat-Recoverable Composition and Article,” which, herein, is incorporated by reference in its entirety. Other embodiments of the present invention include applying a coating of epoxy to the sleeve as an adhesive for affixing the sleeve during application.

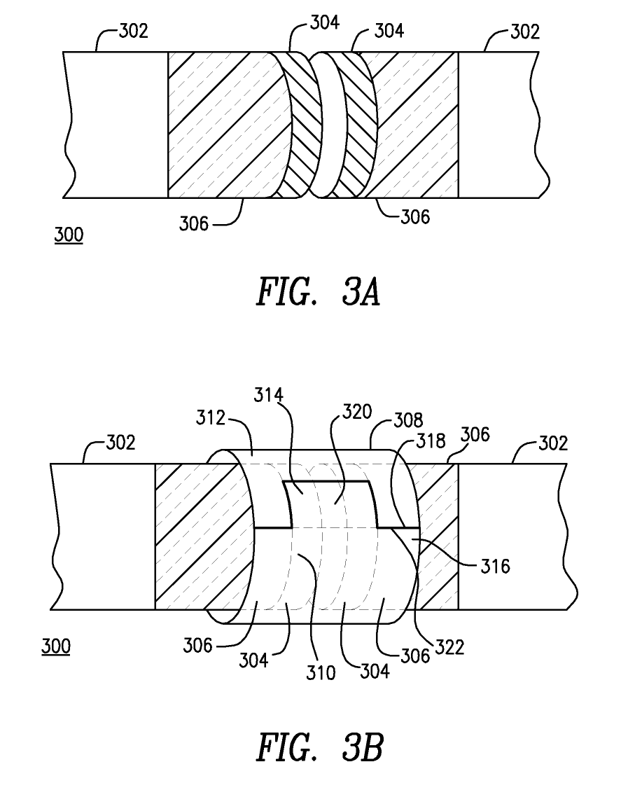

FIG. 3A depicts a system 300 of two apparatuses 302 joining together, according to an embodiment of the present invention. The apparatuses 302 may be any apparatuses upon which a heat-shrinkable article would be applied, such as, a conduit, a pipe, an air duct, and the like. In FIG. 3A, the apparatuses 302 are pipes joining end to end.

The pipes 302 may be made primarily of material 304, such as metal, that has a lower bonding temperature to apply a heat-shrinkable article than an area of the pipe 302 that may be coated with a protective coating 306, such as, for example, a thermoplastic corrosion protective coating, which has a higher bonding temperature when applying a heat-shrinkable article. When joined end to end, the metal 304 may be exposed to facilitate sealing of the pipes 302 together.

FIG. 3B illustrates a heat-shrinkable article 308 in application. In FIG. 3B, the heat-shrinkable article 308 is a heat-sleeve applied to pipes 302 to seal the pipes 302 end to end to create a pipe joint, and protecting the pipe joint from operational conditions and environmental elements that could degrade the pipe in operation. As shown, the heat-sleeve 308 covers an area of the pipe ends comprising a low-bond temperature area 304 or metal, and a high-bond temperature area 306, or protective coating. As shown in FIG. 3A, the low-bond temperature area 304 may be an area where the pipe metal is exposed, such as exposed steel. The high-bond temperature area 306 may be an area where the pipe is coated with a corrosion protective coating, such as a coating made of polypropylene. An embodiment of the present invention depicts a high-bond temperature area 306 as an area of a pipe covered with a thermoplastic material used during operation of the pipe.

The heat-sleeve 308 may comprise a thermoset cross-linked polymeric composition having at least one polypropylene polymer and at least one polyethylene polymer, the thermoset cross-linked polymeric composition having a polypropylene content of less than about 50 percent by weight, and having a polyethylene content of less than about 50 percent by weight, based on the total weight of the cross-linked polymeric composition. An adhesive compound is applied to a side of the heat-sleeve that is placed adjacent to the pipes 302. The heat-sleeve 308 has a first end 310 and a second end 312, wherein the first end 310 has at least one extended portion 314 and one or more non-extended portions 316. In an embodiment of the present invention, the extended portion 314 is sized from about 5 centimeters to about 10 centimeters in height from the non-extended portions 316.

When the heat-sleeve 308 is applied to the pipes 302, the heat-sleeve 308 wraps around the pipe ends and the first end 310 and the second end 312 are positioned such that the extended portion 314 substantially covers the exposed pipe metal 304 and is layered with an area 320 of the second end 312, producing a double layer of heat-sleeve material 308. The non-extended portions 316 are positioned to substantially cover the protective coating 306 of the pipe but not the exposed pipe metal 304. Further, the non-extended portions 316 are positioned such that an edge portion 322 of the non-extended portions 316 abuts a first edge portion 320 of the second end 312, producing a single layer of heat-sleeve material 308.

Heat then is applied to the system 300 to cause shrinkage of the heat-sleeve 308 to the pipe ends and to activate the adhesive compound, thereby sealing the pipe ends. The heat penetration rate necessary to penetrate the single layer of heat-sleeve material 308 covering the low-bond temperature are 306 and sufficiently adhere the non-extended portions 316 and the second end 312 is substantially similar to the heat penetration rate necessary to penetrate the double layers of the heat-sleeve material 308 covering the low-bond temperature area 304 to adhere the extended portion 314 of the first end 310 and the area 320 of the second end 312. The result is an optimum uniform adhesion of the heat-sleeve 308 to the pipes 302.

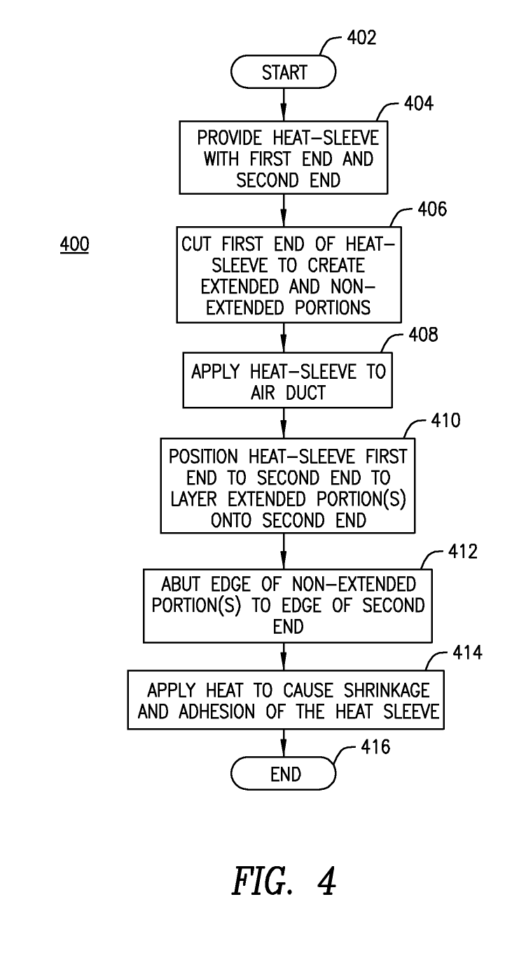

FIG. 4 illustrates a method describing an embodiment of the present invention. The steps need not necessarily be in the sequence illustrated, and some may occur essentially simultaneously. A method 400 begins at step 402, and, at step 404, a heat-shrinkable article, such as a heat-sleeve, is provided, where the heat-sleeve has a first end and a second end, and a layer of an adhesive compound applied to a side of the heat-sleeve. At step 406, the first end of the heat-sleeve is cut just prior to application to produce at least one extended portion and at least one non-extended portion. The first end is cut such that the extended portion(s) apply to a low-bond temperature area of an apparatus, such as, for example, an air duct, and the non-extended portion(s) apply to a high-bond temperature area of the apparatus. In another embodiment of the present invention, the first end is pre-cut to provide at least one extended portion and one non-extended portion during the heat-sleeve manufacturing process.

At step 408, the heat-sleeve is applied to an air duct where both a low-bond temperature area and a high-bond temperature area exist, such as, for example, an area of exposed steel (low-bond temperature) and an area with a thermoplastic coating (high-bond temperature). At step 410, the first end and the second end of the heat-sleeve are positioned such that the extended portion(s) of the first end are layered upon one or more areas of the second end, depending on the cutting design of the first end. For example, an embodiment of the present invention provides a method comprising cutting a first end of a heat-sleeve to create multiple alternating extended and non-extended portions due to multiple areas with low-bond and high-bond temperatures positioned adjacent to each other.

At step 412, the non-extended portion(s) are positioned such that an edge of the non-extended portion(s) abuts a first edge of the second end but does not layer the second end. To cause shrinkage of the heat-sleeve to conform to the air duct and produce a seal, in step 414, heat is applied substantially uniformly to the air duct and the heat-sleeve, activating the adhesive compound and adhering the heat-sleeve to the air duct. Because the first end and the second end of the heat-sleeve are layered only over the low-bond temperature area(s) of the air duct and not the high-bond temperature area(s), the heat penetration rate necessary to adhere the single-layer portion of the heat-sleeve to the high-bond temperature area is similar to the heat penetration rate necessary to adhere the double-layer portion of the heat-sleeve to the low-bond temperature areas, providing optimal adhesion of the entire heat-sleeve to the air duct while allowing for shrinkage of the heat-sleeve without exposure of the air duct. The method then ends at step 416.

While the foregoing is directed to embodiments of the present invention, other and further embodiments of the present invention may be devised without departing from the basic scope thereof, and the scope thereof is determined by the claims that follow.

We claim:

1. A method, comprising:
providing a heat-shrinkable article comprising a thermoset cross-linked polymeric composition having at least one polypropylene polymer and at least one polyethylene polymer, the thermoset cross-linked polymeric composition having a polypropylene content of less than about 50 percent by weight, and having a polyethylene content of less than about 50 percent by weight, based on the total weight of the cross-linked polymeric composition, the heat-shrinkable article having a first end and a second end, wherein the first end has at least one extended portion and one non-extended portion, wherein the second end has a first area and a first edge portion;
applying an adhesive compound to the heat-shrinkable article;
applying the heat-shrinkable article to an apparatus;
positioning the heat-shrinkable article to the apparatus such that the adhesive compound contacts the apparatus;
layering the at least one extended portion onto the first area of the second end;
abutting the at least one non-extended portion to the first edge portion of the second end; and
causing heat-shrinkage of the heat-shrinkable article.

2. The method of claim 1, further comprising forming the at least one extended portion to be about 5 centimeters to about 10 centimeters in height from the at least one non-extended portion.

3. The method of claim 1, further comprising:
positioning the at least one extended portion to cover at least one low-bond temperature area of the apparatus; and
positioning the at least one non-extended portion to cover at least one high-bond temperature area of the apparatus.

4. The method of claim 3, wherein the at least one low-bond temperature area comprises a metal.

5. The method of claim 3, wherein the at least one high-bond temperature area comprises a thermoplastic material.

6. The method of claim 3, wherein the at least one high-bond temperature area comprises a corrosion protection coating.

7. The method of claim 1, wherein causing heat-shrinkage of the heat-shrinkable article further comprises applying heat substantially uniformly to the heat-shrinkable article.

8. A method, comprising:
providing a thermoset cross-linked polymeric heat-shrinkable article having a first end and a second end, wherein the first end has at least one extended portion and one non-extended portion, wherein the second end has a first area and a first edge portion;
applying an adhesive compound to the heat-shrinkable article;
applying the heat-shrinkable article to an apparatus;
positioning the heat-shrinkable article to the apparatus such that the adhesive compound contacts the apparatus;
layering the at least one extended portion onto the first area of the second end;
abutting the at least one non-extended portion to the first edge portion of the second end; and
causing heat-shrinkage of the heat-shrinkable article.

9. The method of claim 1, wherein the apparatus is selected from the group consisting of conduits, air ducts, and piping apparatuses.

10. A thermoset cross-linked polymeric heat-shrinkable article, comprising:
a first end having at least one extended portion and one non-extended portion;
a second end having a first area and a first edge portion; and
an adhesive compound applied to the heat-shrinkable article.

11. The heat-shrinkable article of claim 10, wherein the thermoset cross-linked polymeric composition comprises:
at least one polypropylene polymer; and
at least one polyethylene polymer,
wherein the thermoset cross-linked polymeric composition has a polypropylene content of less than about 50 percent by weight, and a polyethylene content of less than about 50 percent by weight, based on the total weight of the cross-linked polymeric composition.

12. The heat-shrinkable article of claim 10, wherein the heat-shrinkable article is a heat-sleeve.

13. The heat-shrinkable article of claim 10, wherein the at least one extended portion is dimensioned to apply to a low-bond temperature area of an apparatus and the at least one non-extended portion is dimensioned to apply to a high-bond temperature area.

14. The heat-shrinkable article of claim 10, wherein the adhesive compound is selected from the group consisting of a hot-seal adhesive compound, a pressure-sensitive adhesive compound, an epoxy, and any combination thereof.
